(19) United States
(12) Patent Application Publication
(10) Pub. No.: US 2019/0118170 A1
(43) Pub. Date: Apr. 25, 2019

(54) Catalyst Carrier

(71) Applicant: Saint-Gobain Ceramics & Plastics, Inc., Worcester, MA (US)

(72) Inventor: John S. Reid, Wooster, OH (US)

(21) Appl. No.: 16/220,088

(22) Filed: Dec. 14, 2018

Related U.S. Application Data
(62) Division of application No. 15/278,074, filed on Sep. 28, 2016, now abandoned.
(60) Provisional application No. 62/241,788, filed on Oct. 15, 2015.

(51) Int. Cl. B01J 35/04; B01J 35/10; B01J 35/00

(52) U.S. Cl. CPC B01J 35/04; B01J 35/10; B01J 35/1028; B01J 35/1023; B01J 35/002

(57) ABSTRACT

A catalyst carrier may have a cross-sectional shape that may include a plurality of surface channels having a first channel width and a second channel width, where the first channel width may be closer to a periphery of the cross-sectional shape than the second channel width and the first channel width may be less than the second channel width. The cross-sectional shape may further include a plurality of surface features where at least one surface feature is located between at least one pair of surface channels. The cross-sectional shape may further include a ratio L_{OC}/L_{SCP} of at least about 1.7, where L_{OC} is a length of a total contour of the cross-sectional shape and L_{SCP} is a length of an outer simple convex perimeter of the cross-sectional shape.

### CROSS-REFERENCE TO RELATED APPLICATION

This application is a divisional application of U.S. Ser. No. 15/278,074, filed Sep. 28, 2016, now abandoned, and claims the benefit of U.S. Provisional Application No. 62/241,788 filed Oct. 15, 2015.

### FIELD OF THE DISCLOSURE

The present disclosure relates to catalyst carriers. More particularly, the present disclosure relates to particular structural designs for catalyst carriers.

### BACKGROUND

Catalyst carriers may be used in a wide variety of applications and, in particular, the structural design of catalyst carriers is directly connected to their performance during a catalytic process. Generally, a catalyst carrier needs to possess, in combination, at least a minimum surface area on which a catalytic component may be deposited, known as a geometric surface area (GSA), high water absorption and crush strength. In addition, catalytic processes may include packing multiple catalyst carriers in a reactor tube where the general structure of the carriers affects the packing ability of the particles and thus the flow of fluid through the reactor tube. In such reactor tubes, geometric size and shape of the carrier, including GSA, must be balanced with the resistance to fluid flow caused by the packing of the catalytic particles, a performance parameter known as pressure drop and other parameters, such as, piece count. In catalyst carrier design, an increase in certain structural characteristics, such as GSA, due to alterations to known catalyst carrier shapes generally means reduction in catalyst carrier performance when packed in a reactor tube, for example, increased pressure drop or a reduction in the number of catalyst carriers that may be packed into the reaction tube (i.e., piece count). Maintaining the necessary balance between GSA and desired performance parameters of a catalyst carrier is achieved by extensive experimentation making the catalyst carrier art even more unpredictable than other chemical process art. Accordingly, the industry continues to demand improved catalyst carrier designs that maximize desired carrier characteristics while maintaining suitable performance standards.

### SUMMARY

According to one aspect of the invention, a catalyst carrier may have a cross-sectional shape that may include a plurality of surface channels having a first channel width and a second channel width, where the first channel width may be closer to a periphery of the cross-sectional shape than the second channel width and the first channel width may be less than the second channel width. The cross-sectional shape may further include a plurality of surface features where at least one surface feature is located between at least one pair of surface channels. The cross-sectional shape may further include a ratio L_{OC}/L_{SCP} of at least about 1.7, where L_{OC} is a length of a total contour of the cross-sectional shape and L_{SCP} is a length of an outer simple convex perimeter of the cross-sectional shape.

According to yet another aspect of the invention, a catalyst carrier may have a cross-sectional shape that may include a plurality of surface channels having a first channel width and a second channel width, where the first channel width may be closer to a periphery of the cross-sectional shape than the second channel width and the first channel width may be less than the second channel width. The cross-sectional shape may further include a plurality of surface features where at least one surface feature is located between at least one pair of surface channels. The cross-sectional shape may further include a ratio GSA/dP of at least about 0.62 (m²/m³)/(Pa/m), where GSA is a geometric surface area of the catalyst carrier and dP is a pressure drop of the catalyst carrier as measured at a mass flow of 2440 kg/m²*hr (500 lbs/ft²*hr).

According to still another embodiment, a catalyst carrier may have a cross-sectional shape that may include a plurality of surface channels having a first channel width and a second channel width, where the first channel width may be closer to a periphery of the cross-sectional shape than the second channel width and the first channel width may be less than the second channel width. The cross-sectional shape may further include a plurality of surface features where at least one surface feature is located between at least one pair of surface channels. The cross-sectional shape may further include a ratio GSA/PC^{1/3} of at least about 5.9, where GSA is a geometric surface area (m²/m³) of the catalyst carrier and PC is a calculated piece count measured in (pieces per m³).

### BRIEF DESCRIPTION OF THE DRAWINGS

The present disclosure may be better understood, and its numerous features and advantages made apparent to those skilled in the art by referencing the accompanying drawings.

FIG. 1 includes an illustration of a catalyst carrier in accordance with an embodiment described herein;

FIG. 2 includes an illustration of a cross-sectional shape of the catalyst carrier illustrated in FIG. 1 and in accordance with an embodiment described herein;

FIG. 3 includes an illustration of a cross-sectional shape of a catalyst carrier in accordance with an embodiment described herein;

FIGS. 4a-4h include images of catalyst carrier batches illustrating the cross-sectional shapes of comparative catalyst carrier examples;

FIGS. 5a and 5b include images of catalyst carrier batches illustrating the cross-sectional shapes of example catalyst carriers in accordance with embodiments described herein;

FIG. 6 includes a plot showing the ratio L_{OC}/L_{SCP} measured for comparative catalyst carrier examples and catalyst carrier examples in accordance with embodiments described herein;

FIG. 7 includes a plot of “Geometric Surface Area (GSA)” versus “Pressure Drop (dP)” measured for comparative catalyst carrier examples and catalyst carrier examples in accordance with embodiments described herein; and

FIG. 8 includes a plot of “Piece Count” versus “Geometric Surface Area” measured for comparative catalyst carrier examples and catalyst carrier examples in accordance with embodiments described herein.

The use of the same reference symbols in different drawings indicates similar or identical items.

### DETAILED DESCRIPTION

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

As used herein, and unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

It will be appreciated that the terms “catalyst carrier” or “catalyst carriers” as used herein may refer to uncoated catalyst carriers or catalyst carriers coated with a catalyst. It will be further appreciated that whether the catalyst carrier is uncoated or coated, does not change the fundamental characteristics of the carrier as described herein.

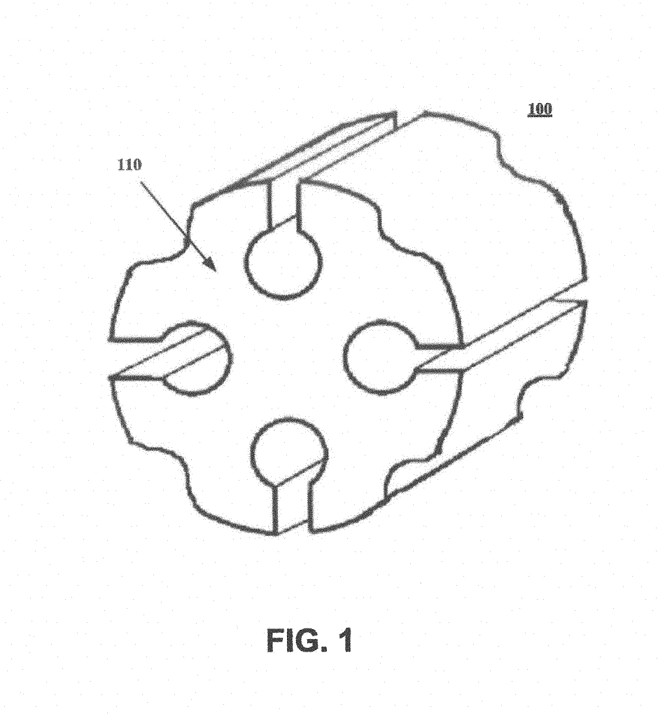

A catalyst carrier having a particular structure is described herein. For purposes of illustration, FIG. 1 includes an image of an embodiment of a catalyst carrier described herein. As illustrated in FIG. 1, a catalyst carrier 100 may have a particular cross-sectional shape 110. The cross-sectional shape 110 of the catalyst carrier may be defined as the two-dimensional shape of any cross-section of the catalyst carrier 100.

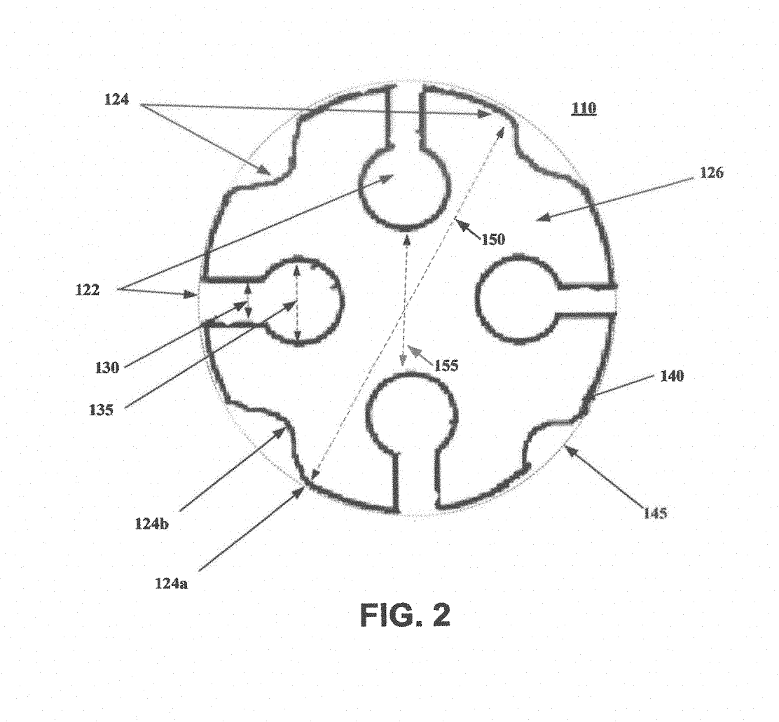

FIG. 2 includes an image of the cross-sectional shape 110 of the catalyst carrier 100 illustrated in FIG. 1. As illustrated in FIG. 2, the cross-sectional shape 110 may include a plurality of surface channels 122 and a plurality of external surface features 124. According to a certain embodiment, the cross-sectional shape 110 may have a substantially continuous shape, meaning that the area enclosed by the outer contour of the cross-sectional shape 110 does not include any closed features (i.e., features that are not open to the outer periphery of the cross-sectional shape 110).

According to a particular embodiment, a surface channel 122 may be defined as any portion of the cross-sectional shape 110 having a contour creating a partially enclosed space that opens to a periphery of the cross-sectional shape 110. The surface channel 122 may have a varying width, referred to herein as a varying channel width. The varying channel width of the surface channels 122 may include at least a first channel width 130 and a second channel width 135, where the first channel width 130 is located closer to the periphery of the cross-sectional shape 110 than the second channel width 135 and where the first channel width 130 is less than the second channel width 135, creating the partially enclosed space of the surface channels 122. It will be appreciated that if a surface channel 122 includes a first channel width 130 and a second channel width 135, it does not mean that the widths of the channel are constant. Rather, the first and second channel widths may be particular measurements at particular locations of the surface channel 122.

An external surface feature 124 in the cross-sectional shape 110 may be defined as any variation or deviation in the contour of the cross-sectional shape 110 from a smooth or generally smooth arcuate or flat contour that is outside of or not included as part of the contour of the surface channel 122. According to particular embodiments, an external surface feature 124 may have an outward facing orientation indicating that the feature deviates outward from a smooth or generally smooth arcuate or flat shape as illustrated by external surface feature 124a or an external surface feature 124 may have an inward facing orientation indicating that the feature deviates inward from a smooth or generally smooth arcuate or flat shape as illustrated by external surface feature 124b. It will be appreciated that an external surface feature 124 may be described as having any desirable geometric shape. For example, according to certain embodiments, the external surface feature 124 may have a convex arcuate shape. According to still another embodiment, the external surface feature 124 may have a concave arcuate shape. According to yet another embodiment, the external surface feature 124 may have a concave triangular shape. According to still another embodiment, the external surface feature 124 may have a convex triangular shape.

According to particular embodiments, a cross-sectional shape 110, as shown in FIG. 2, may have a particular number of external surface features 124 located between at least one pair of adjacent surface channels 122. For example, a cross-sectional shape 110 may include at least one external surface feature 124 between at least one pair of adjacent surface channels 122, such as, at least two external surface features 124 between at least one pair of adjacent surface channels 122, at least three external surface features 124 between at least one pair of adjacent surface channels 122, at least four external surface features 124 between at least one pair of adjacent surface channels 122, at least five external surface features 124 between at least one pair of adjacent surface channels 122, at least six external surface features 124 between at least one pair of adjacent surface channels 122, at least seven external surface features 124 between at least one pair of adjacent surface channels 122, at least eight external surface features 124 between at least one pair of adjacent surface channels 122, at least nine external surface features 124 between at least one pair of adjacent surface channels 122 or even at least ten external surface features 124 between at least one pair of adjacent surface channels 122.

According to still another embodiment, a cross-sectional shape 110 may have a particular number of external surface features 124 located between adjacent surface channels 122. For example, a cross-sectional shape 110 may include at least one external surface feature 124 between adjacent surface channels 122, such as, at least two external surface features 124 between adjacent surface channels 122, at least three external surface features 124 between adjacent surface channels 122, at least four external surface features 124 between adjacent surface channels 122, at least five external surface features 124 between adjacent surface channels 122, at least six external surface features 124 between adjacent surface channels 122, at least seven external surface features 124 between adjacent surface channels 122, at least eight external surface features 124 between adjacent surface channels 122, at least nine external surface features 124 between adjacent surface channels 122 or even at least ten external surface features 124 between adjacent surface channels 122.

Referring back to FIG. 2, the cross-sectional shape 100 may have an outer contour 140 and an outer simple convex perimeter 145. The outer contour 140 may be defined as the full outer perimeter of the cross-sectional shape 110 including the individual contours of all surface channels 122 and external surface features 124. The simple convex perimeter 145 is defined as the length of the perimeter of a circle having the diameter equal to the “X dimension”. The X dimension is the largest diameter of the cross-sectional shape 110.

According to still another embodiment, external surface features 124 located between adjacent surface channels 122 may be combined to define lobe 126. According to certain embodiments a lobe 126 may be a multi-sected tip lobe indicating that the lobe includes at least 2 distinct tips. According to still another embodiment, a lobe 126 may include at least about 3 tips, such as, at least about 4 tips or even at least about 5 tips.

According to yet another particular embodiment, a cross-sectional shape may have a particular number of internal surface features. An internal surface feature in a cross-sectional shape may be defined as any variation or deviation in the contour of the cross-sectional shape from a smooth or generally smooth arcuate or flat contour that is inside of or included as part of the contour of a surface channel. FIG. 3 includes an image of the cross-sectional shape 310, having a particular number of internal surface features 324 located within the partially enclosed space of a surface channel 322. According to certain embodiments, a cross-sectional shape 310 may include at least one internal surface feature 324 included as part of the contour of a surface channel 322, such as, at least two internal surface features 324 included as part of the contour of a surface channel 322, at least three internal surface features 324 located within the partially enclosed space of a surface channel 322, at least four internal surface features 324 included as part of the contour of a surface channel 322, at least five surface internal features 324 included as part of the contour of a surface channel 322, at least six internal surface features 324 included as part of the contour of a surface channel 322, at least seven internal surface features 324 included as part of the contour of a surface channel 322, at least eight internal surface features 324 included as part of the contour of a surface channel 322, at least nine internal surface features 324 included as part of the contour of a surface channel 322 or even at least ten surface features 324 included as part of the contour of a surface channel 322.

According to certain embodiments, referring back to FIG. 2, the outer contour 140 of the cross-sectional shape 110 may have a total length L_{OC} and the outer simple convex perimeter 145 of the cross-sectional shape 110 may have a total length L_{SCP}. According to certain embodiments, the cross-sectional shape 110 may have a particular ratio L_{OC}/L_{SCP}. For example, the cross-sectional shape 110 may have a ratio L_{OC}/L_{SCP} of at least about 1.7, such as, at least about 1.75, at least about 1.8, at least about 1.85, at least about 1.9, at least about 1.95, at least about 2.0, at least about 2.05, at least about 2.1, at least about 2.15, at least about 2.2, at least about 2.25, at least about 2.3, at least about 2.35, at least about 2.4, at least about 2.45, at least about 2.5, at least about 2.55, at least about 2.6, at least about 2.65, at least about 2.7, at least about 2.75 or even at least about 2.79. According to still another embodiment, the cross-sectional shape 110 may have a ratio L_{OC}/L_{SCP} of not greater than about 2.8, such as, not greater than about 2.75, not greater than about 2.7, not greater than about 2.65, not greater than about 2.6, not greater than about 2.55, not greater than about 2.5, not greater than about 2.45, not greater than about 2.4, not greater than about 2.35, not greater than about 2.3, not greater than about 2.25, not greater than about 2.2, not greater than about 2.15, not greater than about 2.1, not greater than about 2.05, not greater than about 2.0, not greater than about 1.95, not greater than about 1.9, not greater than about 1.85, not greater than about 1.8 or even not greater than about 1.75. It will be appreciated that the cross-sectional shape 110 may have a ratio L_{OC}/L_{SCP} of any value between any of the minimum and maximum values noted above. It will be further appreciated that the cross-sectional shape 110 may have a ratio L_{OC}/L_{SCP} of any value within a range between any of the minimum and maximum values noted above.

According to still other embodiments, a catalyst carrier may have a particular geometric surface area GSA. The geometric surface area of a catalyst carrier of a particular nominal shape and size is the standardized GSA typically expressed as square meters per cubic meters (m²/m³). The GSA of the catalyst carrier is determined by measuring the average surface area of a single catalyst carrier having average dimensions of a batch of catalyst carriers, then calculating the piece count of the batch of catalyst carriers and multiplying the surface area of the single catalyst carrier by the piece count. To measure the GSA of the single average catalyst carrier having a shape with two equivalent parallel end-faces, the area of the end faces are determined using an image analysis technique in which the dimensions along all the inner and outer contours along a cross-section or end face are measured. The image analysis technique results in the determination of the end face area and also the total perimeter. Next, the surface area along the length of the single average catalyst carrier is determined by measuring the average length of the single average catalyst carrier with calipers and multiplying the average length by the total perimeter of the average catalyst carrier. This surface area along the length is added to 2 times the end face area to obtain the total geometric surface area of the single average catalyst carrier. The piece weight of the catalyst carrier is determined by taking at least 100 pieces of the catalyst carrier, each having dimensions representative of the nominal, weighing them as a group, and dividing by the exact number of pieces. The packing density of the nominal carrier of the specific material of construction is measured using a calibrated cylinder with a diameter at least 10 times the diameter of the longest dimension of the shape being measured. It is preferred that the cylinder have a calibrated volume (V) of at least 1000 ml or 1/16 ft³. It is also preferred that the cylinder be made from stainless steel. Using a scoop, the cylinder is filled approximately half full, and then placed on a metal plate and raised 12.7 mm (0.5 inches) and allowed to drop. The dropping is repeated a total of ten times. Then, using the scoop, the cylinder is filled to the top and is raised 12.7 trim and allowed to drop, repeating for a total of ten times. Additional media is added to fill the cylinder to overflowing, and a metal straight edge is used to level the top surface. The content of the cylinder is weighed to 0.1 g. The packing density is calculated as the weight divided by the cylinder volume, typically expressed as kg/m³, g/cc or lbs/ft³. Once the single average piece GSA, the average piece weight, and the average packing density are determined, the piece count is then determined by multiplying the packing density in kg/m³ by 1000 and dividing by the piece weight in grams per piece to obtain pieces per m³. The piece count (pc/m³) can then be multiplied by the GSA of the single average catalyst carrier (m²/pc) to obtain the standardized GSA (m²/m³).

Referring back to FIG. 1 for purposes of illustration, a catalyst carrier 100 may have a GSA of at least about 700 m²/m³, such as, at least about 750 m²/m³, at least about 800 m²/m³, at least about 850 m²/m³, at least about 900 m²/m³, at least about 950 m²/m³, at least about 1000 m²/m³, at least about 1050 m²/m³, at least about 1100 m²/m³, at least about 1200 m²/m³, at least about 1250 m²/m³, at least about 1300 m²/m³, at least about 1350 m²/m³, at least about 1400 m²/m³, at least about 1450 m²/m³, at least about 1500 m²/m³, at least about 1550 m²/m³, at least about 1600 m²/m³, at least about 1650 m²/m³, at least about 1700 m²/m³, at least about 1750 m²/m³, at least about 1800 m²/m³, at least about 1850 m²/m³, at least about 1900 m²/m³, or even at least about 1950 m²/m³. According to yet another embodiment, a catalyst carrier 100 may have a GSA of not greater than about 2000 m²/m³, such as, not greater than about 1950 m²/m³, not greater than about 1900 m²/m³, not greater than about 1850 m²/m³, not greater than about 1800 m²/m³, not greater than about 1750 m²/m³, not greater than about 1700 m²/m³, not greater than about 1650 m²/m³, not greater than about 1600 m²/m³, not greater than about 1550 m²/m³, not greater than about 1500 m²/m³, not greater than about 1450 m²/m³, not greater than about 1400 m²/m³, not greater than about 1350 m²/m³, not greater than about 1300 m²/m³, not greater than about 1250 m²/m³, not greater than about 1200 m²/m³, not greater than about 1100 m²/m³, not greater than about 1.050 m²/m³, not greater than about 1000 m²/m³, not greater than about 950 900 m²/m³, not greater than about 850 m²/m³, not greater than about 800 m²/m³, not greater than about 750 m²/m³ or even not greater than about 700 m²/m³. It will be appreciated that a catalyst carrier 100 may have a GSA of any value between any of the minimum and maximum values noted above. It will be further appreciated that a catalyst carrier 100 may have a GSA of any value within a range between any of the minimum and maximum values noted above.

According to still another embodiment, a catalyst carrier may have a particular pressure drop as measured at a mass flow of 2440 kg/m²*hr (500 lbs/ft²*hr). The pressure drop of a catalyst carrier is the difference in pressure between two points in a fluid carrying system as measured using airflow through a packed bed of catalyst carriers. Initial air pressure is measured at an air inlet point prior to air passing through the packed bed and final air pressure is measured at an air outlet point after air passes through the packed bed. Accordingly, the pressure drop is equal to the difference between the initial air pressure and the final air pressure. For purposes of embodiments described herein, the pressure drop is measured in a vertical column having a diameter of 50 mm and packed media height of 1219.2 mm. The media is poured in to a height of about 610 mm and then the tube is vibrated for 5 seconds. Then, the tube is filled to a height of about 915 mm and vibrated for another 5 seconds. The tube is then filled to a height of about 1.219 mm and vibrated for another 5 seconds. After the final vibration, additional media is added to reach the full 1219.2 mm packed height. The unit is sealed and the blower is run at 5 different airflow settings, allowing 3 to 5 minutes at each setting for stabilization. At each air flow setting, ranging from about 0.3 to 1.1 m per sec, equating to a mass velocity of about 180 to 1110 lbs/ft^{2*}hr (878 to 5417 kg/m²*hr), the manometer pressures are measured. A graph called the pressure drop curve is prepared by charting the pressure difference as a function of the mass velocity. The pressure drop of different types of media can be compared by overlaying the pressure drop curves. A simpler way to compare different media is to select a mid-range mass velocity (2440 kg/m^{2*}hr) and compare at this point on the curves.

Again referring back to FIG. 1 for purposes of illustration, a catalyst carrier 100 may have a pressure drop of at least about 900 Pa/m, such as, at least about 1000 Pa/m, at least about 1100 Pa/m, at least about 1200 Pa/m, at least about 1300 Pa/m, at least about 1400 Pa/m, at least about 1500 Pa/m, at least about 1600 Pa/m, at least about 1700 Pa/m, at least about 1800 Pa/m, at least about 1900 Pa/m, at least about 2000 Pa/m, at least about 2100 Pa/m, at least about 2200 Pa/m, at least about 2300 Pa/m, at least about 2400 Pa/m or even at least about 2500 Pa/m. According to still another embodiment, a catalyst carrier 100 may have a pressure drop of not greater than about 2600 Pa/m, such as not greater than about 2500 Pa/m, not greater than about 2400 Pa/m, not greater than about 2300 Pa/m, not greater than about 2200 Pa/m, not greater than about 2100 Pa/m, not greater than about 2000 Pa/m, not greater than about 1900 Pa/m, not greater than about 1800 Pa/m, not greater than about 1700 Pa/m, not greater than about 1600 Pa/m, not greater than about 1500 Pa/m, not greater than about 1400 Pa/m, not greater than about 1300 Pa/m, not greater than about 1200 Pa/m, not greater than about 1100 Pa/m or even not greater than about 1000 Pa/m. It will be appreciated that a catalyst carrier 100 may have a pressure drop of any value between any of the minimum and maximum values noted above. It will be further appreciated that a catalyst carrier 100 may have a pressure drop of any value within a range between any of the minimum and maximum values noted above.

According to yet another embodiment, a catalyst carrier may have a particular ratio GSA/dP, where GSA is the geometric surface area of the catalyst carrier and dP is the pressure drop of the catalyst carrier as measured at a mass flow of 2440 kg/m²*hr (500 lbs/ft²*hr). Again referring back to FIG. 1 for purposes of illustration, a catalyst carrier 100 may have a ratio GSA/dP of at least about 0.62 (m²/m³)/(Pa/m), such as, at least about 0.64 (m²/m³)/(Pa/m), at least about 0.66 (m²/m³)/(Pa/m), at least about 0.68 (m²/m³)/(Pa/m), at least about 0.7 (m²/m³)/(Pa/m), at least about 0.72 (m²/m³)/(Pa/m), at least about 0.74 (m²/m³)/(Pa/m), at least about 0.76 (m²/m³)/(Pa/m), at least about 0.78 (m²/m³)/(Pa/m), at least about 0.8 (m²/m³)/(Pa/m), at least about 0.82 (m²/m³)/(Pa/m), at least about 0.84 (m²/m³)/(Pa/m), at least about 0.86 (m²/m³) (Pa/m), at least about 0.88 (m²/m³)/(Pa/m), at least about 0.9 (m²/m³)/(Pa/m), at least about 0.92 (m²/m³)/(Pa/m), at least about 0.94 (m²/m³)/(Pa/m) or even at least about 0.96 (m²/m³)/(Pa/m). According to still another embodiment, a catalyst carrier 100 may have a ratio GSA/dp of not greater than about 0.98 (m²/m³)/(Pa/m), such as, not greater than about 0.96 (m²/m³)/(Pa/m), not greater than about 0.94 (m²/m³)/(Pa/m), not greater than about 0.92 (m²/m³)/(Pa/m), not greater than about 0.9 (m²/m³)/(Pa/m), not greater than about 0.88 (m²/m³)/(Pa/m), not greater than about 0.86 (m²/m³)/(Pa/m), not greater than about 0.84 (m²/m³) (Pa/m), not greater than about 0.82 (m²/m³)/(Pa/m), not greater than about 0.8 (m²/m³)/(Pa/m), not greater than about 0.78 (m²/m³)/(Pa/m), not greater than about 0.76 (m²/m³) (Pa/m), not greater than about 0.74 (m²/m³)/(Pa/m), not greater than about 0.72 (m²/m³)/(Pa/m) or even not greater than about 0.7 (m²/m³)/(Pa/m). It will be appreciated that a catalyst carrier 100 may have a ratio GSA/dP of any value between any of the minimum and maximum values noted above. It will be further appreciated that the catalyst carrier 100 may have a ratio GSA/dP of any value within a range between any of the minimum and maximum values noted above.

According to still another embodiment, a catalyst carrier may include a particular piece count. As previously noted herein, the piece count of a catalyst carrier (pieces per m³) is calculated by multiplying the packing density of the catalyst carrier in kg/m³ units by 1000 to convert from kg to g and then dividing by the calculated average piece weight of the catalyst carrier in g/piece.

Again referring back to FIG. 1 for purposes of illustration, a catalyst carrier 100 may, include a piece count of at least about 3,000,000 pc/m³, such as, at least about 4,000,000 pc/m³, at least about 5,000,000 pc/m³, at least about 6,000,000 pc/m³, at least about 7,000,000 pc/m³, at least about 8,000,000 pc/m³, at least about 9,000,000 pc/m³, at least about 10,000,000 pc/m³, at least about 11,000,000 pc/m³ or even at least about 12,000,000 pc/m³. According to still another embodiment, a catalyst carrier 100 may include a piece count of not greater than about 13,000,000 pc/m³, such as, not greater than about 12,000,000 pc/m³, not greater than about 11,000,000 pc/m³, not greater than about 10,000,000 pc/m³, not greater than about 9,000,000 pc/m³, not greater than about 8,000,000 pc/m³, not greater than about 7,000,000 pc/m³, not greater than about 6,000,000 pc/m³, not greater than about 5,000,000 pc/m³ or even not greater than about 4,000,000 pc/m³. It will be appreciated that a catalyst carrier 100 may have a piece count of any value between any of the minimum and maximum values noted above. It will be further appreciated that a catalyst carrier 100 may have a piece count of any value within a range between any of the minimum and maximum values noted above.

According to still another embodiment, a catalyst carrier may include a particular ratio GSA/PC^{1/3}. Again referring back to FIG. 1 for purposes of illustration, a catalyst carrier 100 may have a ratio GSA/PC^{1/3} of at least about 5.9 (m²/m³)/(pieces per m³), such as, at least about 6 (m²/m³)/(pieces per m³), at least about 6.1 (m²/m³)/(pieces per m³), at least about 6.2 (m²/m³)/(pieces per m³), at least about 6.3 (m²/m³) (pieces per m³), at least about 6.4 (m²/m³)/(pieces per m³), at least about 6.5 (m²/m³)/(pieces per m³), at least about 6.6 (m²/m³)/(pieces per m³), at least about 6.7 (m²/m³)/(pieces per m³), at least about 6.8 (m²/m³)/(pieces per m³), at least about 6.9 (m²/m³)/(pieces per m³), at least about 7.0 (m²/m³)/(pieces per m³), at least about 7.1 (m²/m³)/(pieces per m³), at least about 7.2 (m²/m³)/(pieces per m³), at least about 7.3 (m²/m³)/(pieces per m³) or even at least about 7.4 (m²/m³)/(pieces per m³). According to still another embodiment, a catalyst carrier 100 may have a ratio GSA/PC^{1/3} of not greater than about 7.5 (m²/m³)/(pieces per m³), such as, not greater than about 7.4 (m²/m³)/(pieces per m³), not greater than about 7.3 (m²/m³)/(pieces per m³), not greater than about 7.2 (m²/m³)/(pieces per m³), not greater than about 7.1 (m²/m³)/(pieces per m³), not greater than about 7.0 (m²/m³)/(pieces per m³), not greater than about 6.9 (m²/m³)/(pieces per m³), not greater than about 6.8 (m²/m³)/(pieces per m³), not greater than about 6.7 (m²/m³)/(pieces per m³), not greater than about 6.5 (m²/m³)/(pieces per m³), not greater than about 6.4 (m²/m³)/(pieces per m³), not greater than about 6.3 (m²/m³)/(pieces per m³), not greater than about 6.2 (m²/m³)/(pieces per m³), not greater than about 6.1 (m²/m³)/(pieces per m³) or even not greater than about 6.0 (m²/m³)/(pieces per m³). It will be appreciated that a catalyst carrier 100 may have a ratio GSA/PC^{1/3} of any value between any of the minimum and maximum values noted above. It will be further appreciated that a catalyst carrier 100 may have a ratio GSA/PC^{1/3} of any value within a range between any of the minimum and maximum values noted above.

According to still another embodiment, a catalyst carrier may include a particular packing density. As previously noted herein, the packing density of the nominal carrier of the specific material of construction is measured using a calibrated cylinder with a diameter at least 10 times the diameter of the longest dimension of the shape being measured. It is preferred that the cylinder have a calibrated volume (V) of at least 1000 ml or 1/16 ft³. It is also preferred that the cylinder be made from stainless steel. Using a scoop, the cylinder is filled approximately half full, and then placed on a metal plate and raised 12.7 mm (0.5 inches) and allowed to drop. The dropping is repeated a total of ten times. Then, using the scoop, the cylinder is filled to the top and is raised 12.7 mm and allowed to drop, repeating for a total of ten times. Additional media is added to fill the cylinder to overflowing, and a metal straight edge is used to level the top surface. The content of the cylinder is weighed to 0.1 g. The packing density is calculated as the weight divided by the cylinder volume, typically expressed as kg/m³, g/cc or lb/ft³.

Again referring back to FIG. 1 for purposes of illustration, a catalyst carrier 100 may have a packing density of not greater than about 0.55 glee, such as, not greater than about 0.52 glee, not greater than about 0.5 glee, not greater than about 0.47 g/cc, not greater than about 0.45 g/cc, not greater than about 0.42 g/cc or even not greater than about 0.4 g/ee. According to still another embodiment, a catalyst carrier 100 may have a packing density of at least about 0.38 g/cc, such as, at least about 0.4 g/cc, at least about 0.43 glee, at least about 0.45 glee, at least about 0.48 g/cc or even at least about 0.5 glee. It will be appreciated that a catalyst carrier 100 may have a packing density ratio packing density of any value between any of the minimum and maximum values noted above. It will be further appreciated that a catalyst carrier 100 may have a packing density of any value within a range between any of the minimum and maximum values noted above.

According to yet another embodiment, a cross-sectional shape of a catalyst carrier may have a particular outer contour total length L_{OC}. Again referring back to FIG. 2 for purposes of illustration, a cross-sectional shape 110 may have an outer contour total length L_{OC} of at least about 10 mm, such as, at least about 12 mm, at least about 15, at least about 17 mm, at least about 20 mm, at least about 22 mm, at least about 25 mm, at least about 27 mm, at least about 30 mm, at least about 32 mm, at least about 35 mm, at least about 37 mm, at least about 40 mm, at least about 42 mm, at least about 45 mm, at least about 47 mm or even at least about 49 mm. According to yet another embodiment, a cross-sectional shape 110 may have an outer contour total length L_{OC} of not greater than about 50 mm, such as, not greater than about 48 mm, not greater than about 45 mm, not greater than about 43 mm, not greater than about 40 mm, not greater than about 38 mm, not greater than about 35 mm, not greater than about 33 mm, not greater than about 30 mm, not greater than about 28 mm, not greater than about 25 mm, not greater than about 23 mm, not greater than about 20 mm, not greater than about 18 mm, not greater than about 15 mm, not greater than about 13 mm or even not greater than about 11 mm. It will be appreciated that a cross-sectional shape 110 may have a L_{OC} of any value between any of the minimum and maximum values noted above. It will be further appreciated that cross-sectional shape 110 may have a L_{OC} of any value within a range between any of the minimum and maximum values noted above.

According to yet another embodiment, a cross-sectional shape of a catalyst carrier may have a particular outer simple convex perimeter total length L_{SCP}. Again referring back to FIG. 2 for purposes of illustration, a cross-sectional shape 110 may have an outer simple convex perimeter total length L_{SCP} of at least about 5 mm, such as, at least about 7 mm, at least about 10 mm, at least about 12 mm, at least about 15, at least about 17 mm, at least about 20 mm, at least about 22 mm, at least about 25 mm, at least about 27 mm or even at least about 29 mm. According to yet another embodiment, a cross-sectional shape 110 may have an outer simple convex perimeter total length L_{SCP} of not greater than about 30 mm, such as, not greater than about 28 mm, not greater than about 25 mm, not greater than about 23 mm, not greater than about 20 mm, not greater than about 18 mm, not greater than about 15 mm, not greater than about 13 mm, not greater than about 10 mm, not greater than about 8 mm or even not greater than about 6 mm. It will be appreciated that a cross-sectional shape 110 may have an outer simple convex perimeter total length L_{SCP} of any value between any of the minimum and maximum values noted above. It will be further appreciated that a cross-sectional shape 110 may have an outer simple convex perimeter total length L_{SCP} of any value within a range between any of the minimum and maximum values noted above.

Again referring back to FIG. 2, a cross-sectional shape 110 may include maximum diameter DM_{MAX} 150 defined as the maximum possible distance between two diametrically, opposite points on the outer contour of the cross-sectional shape 110. A cross-sectional shape 110 may also include a minimum diameter DM_{MIN} 155 defined as the minimum possible distance between two diametrically opposite points on the outer contour of the cross-sectional shape 110.

According to certain embodiments, a cross-sectional shape may include a particular ratio DM_{MAX}/DM_{MIN}. Again referring back to FIG. 2 for purposes of illustration, a cross-sectional shape 110 may have a ratio DM_{MAX}/DM_{MIN} of at least about 1.1, such as, at least about 1.2, at least about 1.3, at least about 1.4, at least about 1.5, at least about 1.6, at least about 1.7, at least about 1.8, at least about 1.9, at least about 2.0, at least about 2.1 or even at least about 2.2. According to still another embodiment, a cross-sectional shape 110 may have a ratio DM_{MAX}/DM_{MIN} of not greater than about 2.3, such as, not greater than about 2.2, not greater than about 2.1, not greater than about 2.0, not greater than about 1.9, not greater than about 1.8, not greater than about 1.7, not greater than about 1.6, not greater than about 1.5, not greater than about 1.4, not greater than about 1.3 or even not greater than about 1.2. It will be appreciated that a cross-sectional shape 110 may have a ratio DM_{MAX}/DM_{MIN} of any, value between any of the minimum and maximum values noted above. It will be further appreciated that a cross-sectional shape 110 may have a ratio DM_{MAX}/DM_{MIN} of any value within a range between any of the minimum and maximum values noted above.

According to certain embodiments, a cross-sectional shape may include maximum diameter DM_{MAX}. Again referring back to FIG. 2 for purposes of illustration, a cross-sectional shape 110 may have a maximum diameter DM_{MAX} of at least about 1.5 mm, such as, at least about 2 mm, at least about 5 mm, at least about 7 mm, at least about 10 mm, at least about 12 mm, at least about 15 mm, at least about 17 mm, at least about 20 mm, at least about 22 mm or even at least about 24 mm. According to still another embodiment, a cross-sectional shape 110 may have a maximum diameter DM_{MAX} of not greater than about 25 mm, such as, not greater than about 23 mm, not greater than about 20 mm, not greater than about 18 mm, not greater than about 15 mm, not greater than about 13 mm, not greater than about 10 mm, not greater than about 8 mm, not greater than about 5 mm, not greater than about 3 mm or even not greater than about 2 mm. It will be appreciated that a cross-sectional shape 110 may have a maximum diameter DM_{MAX} of any value between any of the minimum and maximum values noted above. It will be further appreciated that a cross-sectional shape 110 may have a maximum diameter DM_{MAX} of any value within a range between any of the minimum and maximum values noted above.

According to certain embodiments, a cross-sectional shape may include a minimum diameter DM_{MIN}. Again referring back to FIG. 2 for purposes of illustration, a cross-sectional shape 110 may have a maximum diameter DM_{MIN} of at least about 1.0 mm, such as, at least about 2 mm, at least about 5 mm, at least about 7 mm, at least about 10 mm, at least about 12 mm, at least about 15 mm, at least about 17 mm, at least about 20 mm or even at least about 22 mm. According to still another embodiment, a cross-sectional shape 110 may have a minimum diameter DM_{MIN} of not greater than about 23 mm, such as, not greater than about 20 mm, not greater than about 18 mm, not greater than about 15 mm, not greater than about 13 mm, not greater than about 10 mm, not greater than about 8 mm, not greater than about 5 mm, not greater than about 3 mm or even not greater than about 2 mm. It will be appreciated that a cross-sectional shape 110 may have a minimum diameter DM_{MIN} of any value between any of the minimum and maximum values noted above. It will be further appreciated that a cross-sectional shape 110 may have a minimum diameter DM_{MIN} of any value within a range between any of the minimum and maximum values noted above.

According to still other embodiment, a catalyst carrier having a cross-sectional shape as described herein may have a particular crush strength (CS). Crush strength is calculated based on ASTM D-4179 (2011). For example, a catalyst carrier may have a crush strength of at least about 10 lbs.

According to still another embodiment, a catalyst carrier having a cross-sectional shape as described herein may further include a particular 3-dimensional shape. For example, the 3-dimensional shape of the catalyst carrier may be generally spherical, meaning that the catalyst carrier may fit within a best-fit sphere while occupying a majority of an interior volume of the best-fit sphere. For example, the catalyst carrier having a generally, spherical shape may occupy at least about 75% of an interior volume of the best-fit sphere, at least about 80% of an interior volume of the best-fit sphere, at least about 85% of an interior volume of the best-fit sphere, at least about 90% of an interior volume of the best-fit sphere, such as, at least about 92% an interior volume of the best-fit sphere, at least about 95% an interior volume of the best-fit sphere, at least about 97% an interior volume of the best-fit sphere or even 99% an interior volume of the best-fit sphere.

According to still another embodiment, a catalyst carrier having a cross-sectional shape as described herein may generally ellipsoidal, meaning that the catalyst carrier may fit within a best-tit ellipsoid while occupying a majority of an interior volume of the best-fit ellipsoid. For example, the catalyst carrier having a generally ellipsoidal shape may occupy at least about 75% of an interior volume of the best-fit ellipsoid, at least about 80% of an interior volume of the best-fit ellipsoid, at least about 85% of an interior volume of the best-fit ellipsoid, at least about 90% of an interior volume of the best-fit ellipsoid, such as, at least about 92% an interior volume of the best-fit ellipsoid, at least about 95% an interior volume of the best-fit ellipsoid, at least about 97% an interior volume of the best-fit ellipsoid or even 99% an interior volume of the best-fit ellipsoid. According to still another embodiment, the cross-sectional shape as described herein may be perpendicular to a longitudinal axis running through a center-point of and along a full length of the best-fit ellipsoid. According to still another embodiment, the cross-sectional shape may include the center point of the best-fit ellipsoid.

According to still another embodiment, a catalyst carrier having a cross-sectional shape as described herein may be generally cylindrical, meaning that the catalyst carrier may fit within a best-fit cylinder while occupying a majority of an interior volume of the best-fit cylinder. For example, the catalyst carrier having a generally cylindrical shape may occupy at least about 75% of an interior volume of the best-fit cylinder, at least about 80% of an interior volume of the best-fit cylinder, at least about 85% of an interior volume of the best-fit cylinder, at least about 90% of an interior volume of the best-fit cylinder, such as, at least about 92% an interior volume of the best-fit cylinder, at least about 95% an interior volume of the best-fit cylinder, at least about 97% an interior volume of the best-fit cylinder or even 99% an interior volume of the best-fit cylinder. According to still another embodiment, the cross-sectional shape as described herein may be perpendicular to a longitudinal axis running through a center-point of and along a full length of the best-fit cylinder. According to still another embodiment, the cross-sectional shape may include the center point of the best-fit cylinder.

According to yet another embodiment, a catalyst carrier having a cross-sectional shape as described herein may be formed using any desirable forming technique capable of producing the catalyst carrier at a constant size and shape. According to still another embodiment, a catalyst carrier having a cross-sectional shape as described herein may be formed using a high speed forming process. For example, a catalyst carrier having a cross-sectional shape as described herein may be formed using an extrusion method. According to yet another embodiment, a catalyst carrier having a cross-sectional shape as described herein may be formed using a pressing method. According to still another embodiment, a catalyst carrier having a cross-sectional shape as described herein may be formed using a molding method.

Many different aspects and embodiments are possible. Some of these aspects and embodiments are described below. After reading this specification, those skilled in the art will appreciate that these aspects and embodiments are only illustrative and do not limit the scope of the present invention. Embodiments may be in accordance with any one or more of the items as listed below.

Item 1. A catalyst carrier having a cross-sectional shape comprising: a plurality of surface channels, each surface channel having a first channel width and a second channel width, wherein the first channel width is closer to a periphery of the cross-sectional shape than the second channel width and wherein the first channel width is less than the second channel width; a plurality of surface features, wherein at least one surface feature is located between at least one pair of adjacent surface channels; and a ratio L_{OC}/L_{SCP} of at least about 1.7, where L_{OC} is a length of a total contour of the cross-sectional shape and L_{SCP} is a length of an outer simple convex perimeter of the cross-sectional shape.

Item 2. A catalyst carrier having a cross-sectional shape comprising: a plurality of surface channels, each surface channel having a first channel width and a second channel width, wherein the first channel width is closer to a periphery of the cross-sectional shape than the second channel width and wherein the first channel width is less than the second channel width; a plurality of surface features, wherein at least one surface feature is located between at least one pair of adjacent surface channels; and wherein the catalyst carrier comprises a ratio GSA/dP of at least about 0.62 (m²/m³)/(Pa/m), where GSA is a geometric surface area of the catalyst carrier and dP is a pressure drop of the catalyst carrier as measured at a mass flow of 2440 kg/m²*hr (500 lbs/ft²*hr).

Item 3. A catalyst carrier comprising a cross-sectional shape comprising: a plurality of surface channels, each surface channel having a first channel width and a second channel width, wherein the first channel width is closer to a periphery of the cross-sectional shape than the second channel width and wherein the first channel width is less than the second channel width; a plurality of surface features, wherein at least one surface feature is located between at least one pair of adjacent surface channels; and wherein the catalyst carrier comprises a ratio GSA/PC_{1/3} of at least about 5.9, where GSA is a geometric surface area (m²/m³) of the catalyst carrier and PC is a calculated piece count (pieces per m³).

Item 4. The catalyst carrier of any one of items 2 and 3, wherein the cross-sectional shape further comprises a ratio L_{OC}/L_{SCP} of at least about 1.7 and not greater than about 2.8, wherein L_{OC} is a length of a total contour of the cross-sectional shape and L_{SCP} is a length of an outer simple convex perimeter of the cross-sectional shape.

Item 5. The catalyst carrier of any one of items 1 and 3, wherein the catalyst carrier further comprises a ratio GSA/dP of at least about 0.62 (m²/m³)/(Pa/m) and not greater than about 0.98, where GSA is a geometric surface area of the catalyst carrier and dP is a pressure drop of the catalyst carrier as measured at a mass flow of 2440 kg/m²*hr (500 lbs/ft²*hr).

Item 6. The catalyst carrier of any one of items 1 and 2, wherein the catalyst carrier further comprises a ratio GSA/PC^{1/3} of at least about 5.9 and not greater than about 7.5, where GSA is the geometric surface area of the catalyst carrier and PC is a calculated piece count.

Item 7. The catalyst carrier of any one of items 1, 2 and 3, wherein the catalyst carrier further comprises a GSA at least about 700 m²/m³ and not greater than about 2000 m²/m³.

Item 8. The catalyst carrier of any one of items 1, 2 and 3, wherein the catalyst carrier further comprises a nominal piece size corresponding to a piece count (PC) of at least about 3,000,000 pc/m³ and not greater than about 13,000,000 pc/m³.

Item 9. The catalyst carrier of any one of items 1, 2 and 3, wherein the catalyst carrier further comprises a pressure drop (dP) of not greater than about 2600 Pa/m and at least about 900 Pa/m, as measured in a 50.8 mm diameter tube packed to a 4 foot height, in ambient air at a mass flow of 2440 Kg/m²*hr.

Item 10. The catalyst carrier of any one of items 1, 2 and 3, wherein the cross-sectional shape comprises a total contour length (L_{OC}) of at least about 10 mm and not greater than about 50 mm.

Item 11. The catalyst carrier of any one of items 1, 2 and 3, wherein the cross-sectional shape comprises a length of the outer simple convex perimeter (L_{SCP}) of at least about 5 mm and not greater than about 30 mm.

Item 12. The catalyst carrier of any one of items 1, 2 and 3, wherein the cross-sectional shape further comprises a plurality of lobes located between adjacent channels.

Item 13. The catalyst carrier of any one of items 12, wherein at least one of the plurality of lobes is a multisected tip lobe.

Item 14. The catalyst carrier of any one of items 13, wherein the multisected tip lobe comprises at least about 3 tips, at least about 4 tips, at least about 5 tips.

Item 15. The catalyst carrier of any one of items 13, wherein the plurality of lobes comprise an outer wall surface and wherein the outer wall surface comprises at least 2 changes in direction.

Item 16. The catalyst carrier of any one of items 1, 2 and 3, wherein the catalyst carrier comprises a crush strength (CS) of at least about 10 lbs.

Item 17. The catalyst carrier of any one of items 1, 2 and 3, wherein a 3-dimensional shape of the catalyst carrier is generally spherical.

Item 18. The catalyst carrier of any one of items 17, wherein the cross-sectional shape includes a center point of the generally spherical shape.

Item 19. The catalyst carrier of any one of items 2 and 3, wherein a 3-dimensional shape of the catalyst carrier is generally ellipsoidal.

Item 20. The catalyst carrier of any one of items 19, wherein the cross-sectional shape includes a center point of the generally ellipsoidal shape.

Item 21. The catalyst carrier of any one of items 19, wherein the cross-sectional shape is perpendicular to a longitudinal axis running a length of the generally ellipsoidal shape through a center point of the generally ellipsoidal shape.

Item 22. The catalyst carrier of any one of items 1, 2 and 3, wherein a 3-dimensional shape of the catalyst carrier is generally cylindrical.

Item 23. The catalyst carrier of any one of items 22, wherein the cross-sectional shape includes a center point of the generally cylindrical shape.

Item 24. The catalyst carrier of any one of items 22, wherein the cross-sectional shape is perpendicular to a longitudinal axis running a length of the generally cylindrical shape through a center point of the generally cylindrical shape.

### EXAMPLES

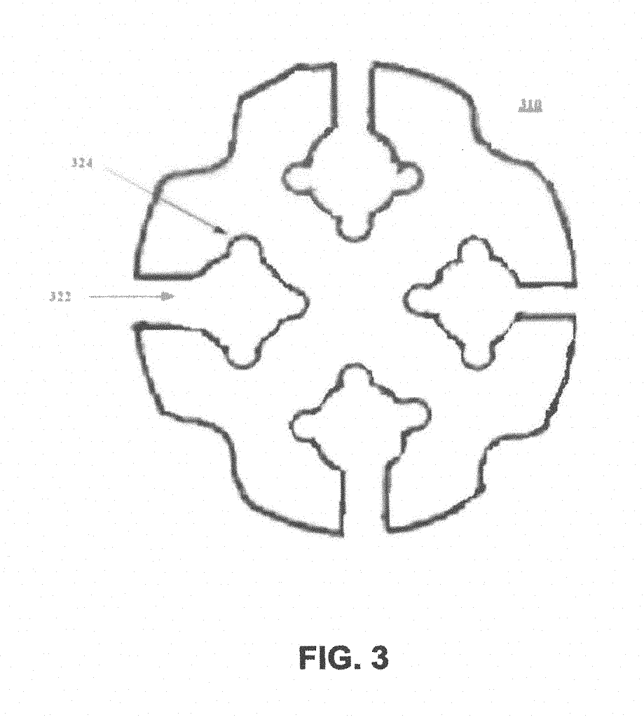

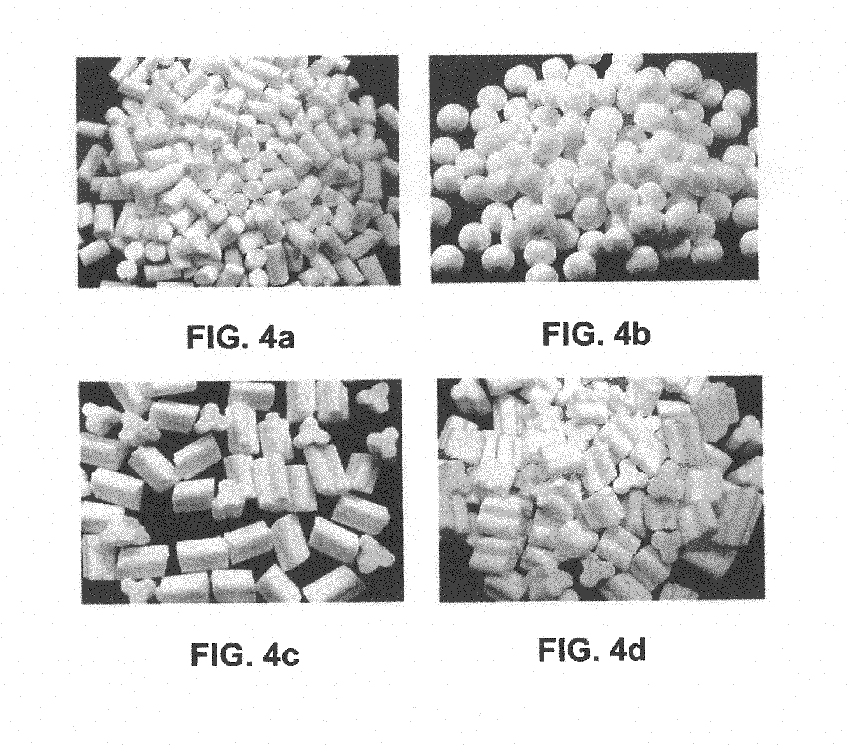

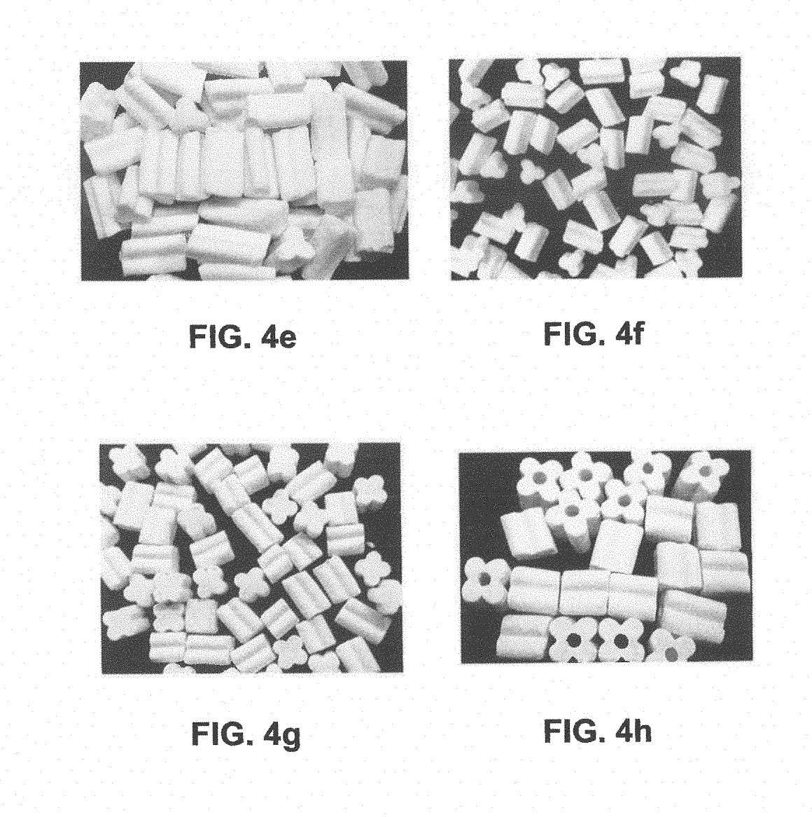

The following includes a comparison between eight comparative catalyst carriers having distinct cross-sectional shapes and example catalyst carriers having cross-sectional shapes according to embodiments described herein. FIGS. 4a-4h include images of catalyst carrier batches illustrating the cross-sectional shapes of Comparative Catalyst Carrier Examples C1-C8. FIG. 4a illustrates the cross-sectional shape of Comparative Catalyst Carrier Example C1, which is described generally as a pellet shaped catalyst carrier. FIG. 4b illustrates the cross-sectional shape of Comparative Catalyst Carrier Example C2, which is described generally as a sphere shaped catalyst carrier. FIG. 4c illustrates the cross-sectional shape of Comparative Catalyst Carrier Example C3, which is described generally as a trilobe shaped pellet catalyst carrier. FIG. 4d illustrates the cross-sectional shape of Comparative Catalyst Carrier Example C4, which is described generally as a trilobe shaped pellet catalyst carrier having a relatively short aspect ratio. FIG. 4e illustrates the cross-sectional shape of Comparative Catalyst Carrier Examples C5, which is described generally as a trilobe shaped pellet catalyst carrier having a relatively long aspect ratio. FIG. 4f illustrates the cross-sectional shape of Comparative Catalyst Carrier Example C6, which is described generally as a trilobe shaped pellet catalyst carrier. FIG. 4g illustrates the cross-sectional shape of Comparative Catalyst Carrier Example C7, which is described generally as a quadrilobe shaped pellet catalyst carrier. FIG. 4h illustrates the cross-sectional shape of Comparative Catalyst Carrier Example C8, which is described generally as a quadrilobe shaped pellet catalyst carrier with a hole.

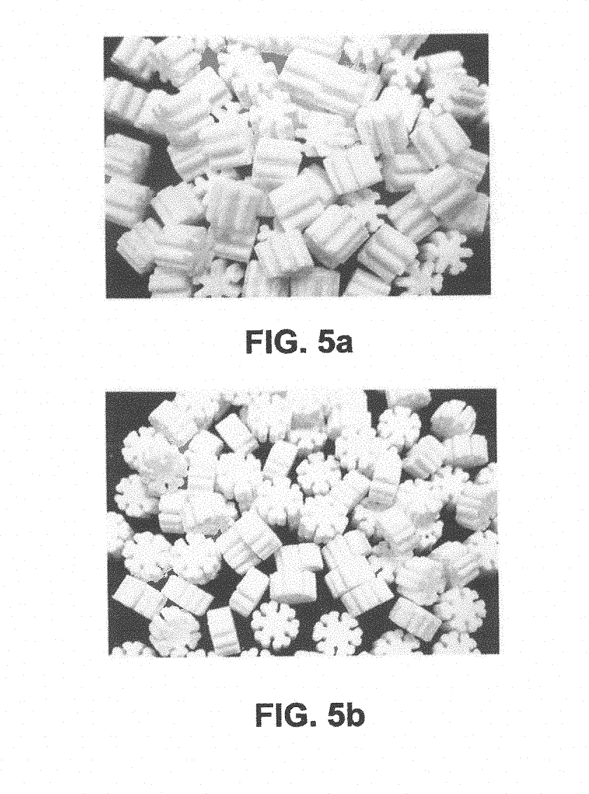

FIGS. 5a and 5b include images of catalyst carrier batches illustrating the cross-sectional shapes of Catalyst Carrier Examples S1 and S2, which include cross-sectional shapes according to embodiments described herein. FIG. 5a illustrates the cross-sectional shape of Example Catalyst Carrier S1. FIG. 5b illustrates the cross-sectional shape of Example Catalyst Carrier S2.

Table 1 includes a summary of physical measurements of the cross-sectional shapes of Comparative Catalyst Carrier Examples C1-C8 and Catalyst Carrier Examples S1 and S2. Physical measurements include the length of the X-dimension for each example, the total contour of the cross-sectional shape (L_{OC}) for each example, the length of outer simple convex perimeter (L_{SCP}) for each example and the ratio L_{OC}/L_{SCP} for each example.

TABLE 1
Catalyst Carrier Cross-Sectional Shape Measurements

| | X-dimension | L_{OC} | L_{SCP} | L_{OC}/ |
|---|---|---|---|---|
| | (mm) | (mm) | (mm) | L_{SCP} |
| C1 | 3.40 | 11 | 11 | 1.0 |
| C2 | 5.20 | 16 | 16 | 1.0 |
| C3 | 5.21 | 19 | 16 | 1.2 |
| C4 | 4.80 | 18 | 15 | 1.2 |
| C5 | 4.81 | 18 | 15 | 1.2 |
| C6 | 4.76 | 18 | 15 | 1.2 |
| C7 | 4.90 | 21 | 15 | 1.3 |
| C8 | 4.90 | 21 | 15 | 1.3 |
| S1 | 5.78 | 33 | 18 | 1.8 |
| S2 | 5.70 | 37 | 18 | 2.1 |

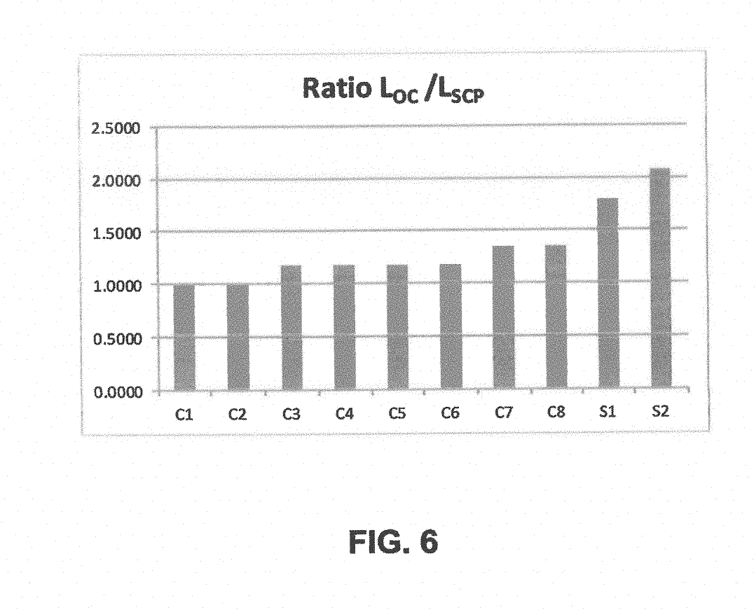

FIG. 6 includes a plot of showing the ratio L_{OC}/L_{SCP} measured for Comparative Catalyst Carrier Examples C1-C8 and Catalyst Carrier Examples S1 and S2. As clearly, illustrated, examples S1 and S2, which include cross-sectional shapes according to embodiments described herein, show a higher ratio L_{OC}/L_{SCP}, indicating a greater useable surface area for the catalyst carrier.

Table 2 includes a summary of certain physical characteristics and performance measurements of the Comparative Catalyst Carrier Examples C1-C8 and Catalyst Carrier Examples S1 and S2. The physical measurements include the geometric surface area (GSA) of each example. The performance measurements include the recorded piece count, pressure drop and crush strength of each example measured.

TABLE 2
Catalyst Carrier Physical and Performance Measurements

| | GSA | dP | | PC | | CS | PcV | | |
|---|---|---|---|---|---|---|---|---|---|
| | (m²/m³) | (in. H₂O/ft) | GSA/dP | (pieces/m³ E+06) | GSA/PC^{1/3} | (lbs) | (mm³) | CS/PcV | CS/PC^{1/3} |
| C1 | 1030 | 4.35 | 237 | 14.1 | 4.26 | 16.0 | 0.0464 | 345 | 0.0662 |
| C2 | 726 | 1.85 | 392 | 8.55 | 3.55 | 12.0 | 0.0736 | 163 | 0.0587 |
| C3 | 731 | 2.35 | 311 | 3.80 | 4.69 | 19.1 | 0.151 | 127 | 0.122 |
| C4 | 921 | 3.20 | 288 | 6.99 | 4.82 | 16.4 | 0.0895 | 183 | 0.0858 |
| C5 | 814 | 2.33 | 349 | 4.25 | 5.03 | 28.7 | 0.144 | 200 | 0.177 |
| C6 | 868 | 2.92 | 297 | 5.33 | 4.97 | 20.1 | 0.117 | 172 | 0.115 |
| C7 | 879 | 2.25 | 391 | 5.43 | 5.00 | 24.1 | 0.117 | 216 | 0.137 |
| C8 | 1040 | 2.10 | 495 | 5.78 | 5.80 | 10.4 | 0.104 | 100 | 0.0580 |
| S1 | 1040 | 1.50 | 693 | 5.12 | 6.04 | 16.2 | 0.0949 | 171 | 0.0940 |
| S2 | 1150 | 1.70 | 676 | 5.11 | 6.68 | 20.0 | 0.102 | 196 | 0.116 |

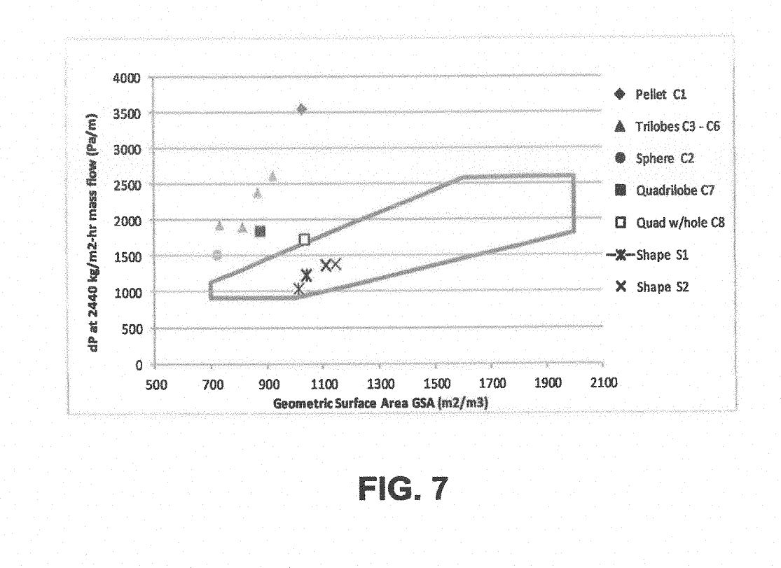

FIG. 7 includes a plot of “Geometric Surface Area (GSA)” versus “Pressure Drop (dP)” measured for the Comparative Catalyst Carrier Examples C1-C8 and Catalyst Carrier Examples S1 and S2. As clearly illustrated, examples S1 and S2, which include cross-sectional shapes according to embodiments described herein, unexpectedly showed low pressure drop while having a relatively high geometric surface area (GSA) as compared to all of the comparative examples.

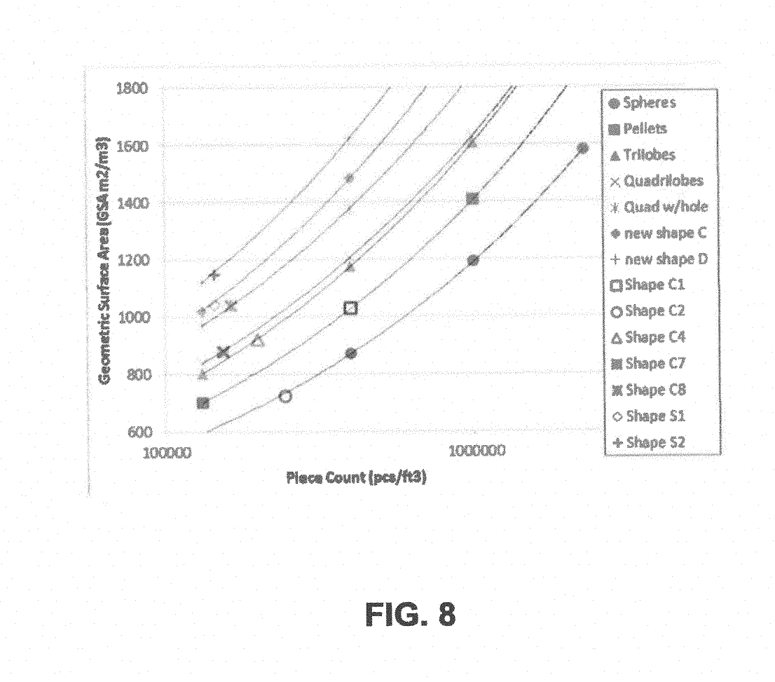

FIG. 8 includes a plot of “Piece Count” versus “Geometric Surface Area” for the Comparative Catalyst Carrier Examples C1, C2, C4, C7 and C8 and Catalyst Carrier Examples S1 and S2. Outlined markers on the plot represent measured values of piece count and GSA for a given catalyst carrier while solid markers represent extrapolated values of piece count and GSA for the give catalyst carrier over a range of catalyst carrier sizes. As clearly illustrated, examples S1 and S2, which include cross-sectional shapes according to embodiments described herein, unexpectedly showed a significantly greater GSA at a given piece count (nominal size) than Comparative Catalyst Carrier Examples C1, C2, C4, C7 and C8. Further, the measurements show that at a given GSA, examples S1 and S2 offer lower piece counts, which will mean lower pressure drop. Accordingly, examples S1 and S2 offer the combination of lower pressure drop and higher GSA.

The Abstract of the Disclosure is provided to comply with Patent Law and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all features of any of the disclosed embodiments. Thus, the following claims are incorporated into the Detailed Description, with each claim standing on its own as defining separately, claimed subject matter.

What is claimed is:

1. A catalyst carrier having a cross-sectional shape comprising:
a plurality of surface channels, each surface channel having a first channel width and a second channel width, wherein the first channel width is closer to a periphery of the cross-sectional shape than the second channel width and wherein the first channel width is less than the second channel width;
a plurality of surface features, wherein at least one surface feature is located between at least one pair of adjacent surface channels; and
wherein the catalyst carrier comprises a ratio GSA/dP of at least about 0.62 (m²/m³)/(Pa/m), where GSA is a geometric surface area of the catalyst carrier and dP is a pressure drop of the catalyst carrier as measured at a mass flow of 2440 kg/m²*hr (500 lbs/ft²*hr).

2. The catalyst carrier of claim 1, wherein the catalyst carrier further comprises a ratio GSA/PC^{1/3} of not greater than about 0.98.

3. The catalyst carrier of claim 1, wherein the catalyst carrier further comprises a ratio GSA/PC^{1/3} of at least about 5.9, where GSA is the geometric surface area of the catalyst carrier and PC is a calculated piece count.

4. The catalyst carrier of claim 1, wherein the catalyst carrier further comprises a GSA at least about 700 m²/m³ and not greater than about 2000 m²/m³.

5. The catalyst carrier of claim 1, wherein the catalyst carrier further comprises a nominal piece size corresponding to a piece count (PC) of at least about 3,000,000 pc/m³ and not greater than about 13,000,000 pc/m³.

6. The catalyst carrier of claim 1, wherein the cross-sectional shape includes a center point of the generally spherical shape.

7. The catalyst carrier of claim 1, wherein a 3-dimensional shape of the catalyst carrier is generally ellipsoidal.

8. The catalyst carrier of claim 1, wherein a 3-dimensional shape of the catalyst carrier is generally cylindrical.
